(19) United States
(12) Patent Application Publication
(10) Pub. No.: US 2005/0197863 A1
(43) Pub. Date: Sep. 8, 2005

(54) Method of making examination appointment, server using the same, and program for making examination appointment

(75) Inventor: Takeshi Funahashi, Kaisei-machi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/067,694

(22) Filed: Mar. 1, 2005

(30) Foreign Application Priority Data
Mar. 4, 2004 (JP) 2004-060422

(51) Int. Cl. G06F 17/60

(52) U.S. Cl. 705/2

(57) ABSTRACT

A server causes an examination request addressee terminal to display contents of examination appointment together with a medical image of a patient as a target of examination. The server includes a first storing unit for storing medical image data; a second storing unit for storing examination appointment data; a first processing unit for displaying, when there is a request from a first client terminal at an examination request client at a time of making an examination appointment, a medical image of the patient in the first client terminal; a second processing unit for causing the second storing unit to store the examination appointment data in correspondence with the medical image data as to the patient; and a third processing unit for displaying contents of the examination appointment data together with the medical image of the patient in a second client terminal at an examination request addressee.

### BACKGROUND OF THE INVENTION

1. Field of the Invention

The present invention relates to a method of making an appointment of an examination for diagnosis via a network. Furthermore, the present invention relates to a server using the method of making an examination appointment and a program for making an examination appointment.

2. Description of a Related Art

Conventionally, in medical facilities such as hospitals, examinations using radiation (X-rays or the like), ultrasonic waves, MR (magnetic resonance) and so on have been performed. In order to perform such an examination, examination equipment and a skilled laboratory technician are required, and it is required to make an examination appointment for securing the examination equipment and the laboratory technician in advance. Recent years, such an examination appointment has been made by using a network-connected device.

In the case where an examination appointment is made by using a network-connected device, operation of inputting contents of the examination request is required. In view of such circumstances, the applicant has proposed an examination requesting method using an image referring device having an image database storing contents of examination request in correspondence with the stored image data, in which method, when patient information about a certain patient is inputted at the time of an examination request, the past images regarding the patient and the contents of examination request are displayed on a display screen of the image referring device, and when there is an input for requesting the same examination as the examination performed in the past, an imaging request is issued based on the display screen (see the front page of Japanese Patent Application Publication JP-A-2003-164442).

By the way, when an appointment of a certain examination, e.g., CT (Computed Tomography) imaging is made via a network from an examination request client terminal, if a past medical image, e.g., X-ray imaging images of a patient as a target of the examination can be seen at the examination request client terminal or an examination request addressee terminal, sometimes making examination appointments may be facilitated. However, the examination requesting method disclosed in the above document is for simplifying operation of the operator in the case where an imaging request in the same condition as in the past examination request is issued by using the image referring device having the image database, but not for displaying contents of the examination request with the a past medical image of the patient as the target of the examination at the examination request client terminal or the examination request addressee terminal connected to the server via the network.

### SUMMARY OF THE INVENTION

The present invention has been achieved in view of the above-described problems. An object of the present invention is to provide a method of making an examination appointment capable of displaying contents of examination request with a past medical image of a patient as a target of the examination in a terminal of an examination request client or an examination request addressee at a time of making an appointment of an examination for diagnosis from the terminal at the examination request client via a network. Another object of the present invention is to provide a server using such a method of making an examination appointment and a program for making an examination appointment.

In order to solve the above-described problems, a method of making an examination appointment according to the present invention is a method of making an appointment of an examination for diagnosis by communicating between a first client terminal at an examination request client and a server and communicating between the server and a second client terminal at an examination request addressee via a network, and the method comprises the steps of: (a) selecting, when a signal of requesting for displaying an medical image is transmitted from the first client terminal to the server at a time of making an examination appointment, medical image data as to a patient as a target of the examination from plural kinds of medical image data stored in a storing medium according to the signal and transmitting the medical image data as to the patient from the server to the first client terminal so as to display a medical image based on the medical image data as to the patient in the first client terminal; (b) transmitting examination appointment data as to the patient from the first client terminal to the server; (c) storing in the server the examination appointment data as to the patient received from the first client terminal in correspondence with the medical image data as to the patient; and (d) transmitting the examination appointment data and the medical image data as to the patient from the server to the second client terminal so as to display contents of the examination appointment data as to the patient together with the medical image based on the medical image data as to the patient in the second client terminal.

Further, a server according to the present invention is a server for making an appointment of an examination for diagnosis by communicating with a first client terminal at an examination request client and communicating with a second client terminal at an examination request addressee via a network, the server comprising: medical image data storing means for storing plural kinds of medical image data; examination appointment data storing means for storing plural kinds of examination appointment data; medical image display processing means for selecting, when a signal of requesting for displaying an medical image is transmitted from the first client terminal to the server at a time of making an examination appointment, medical image data as to a patient as a target of the examination from the plural kinds of medical image data stored in the medical image data storing means according to the signal and transmitting the medical image data as to the patient to the first client terminal so as to display a medical image based on the medical image data as to the patient in the first client terminal; examination appointment data reception processing means for causing the examination appointment data storing means to store the examination appointment data as to the patient received from the first client terminal in correspondence with the medical image data as to the patient; and examination appointment data display processing means for transmitting the examination appointment data and medical image data as to the patient to the second client terminal so as to display contents of the examination appointment data as to the patient together with the medical image based on the medical image data as to the patient in the second client terminal.

Furthermore, a program for making an examination appointment according to the present invention is a program for making an appointment of an examination for diagnosis in a server by communicating between a first client terminal at an examination request client and the server and communicating between the server and a second client terminal at an examination request addressee via a network, the program actuates a CPU to execute the procedures of: (a) selecting, when a signal of requesting for displaying an medical image is transmitted from the first client terminal to the server at a time of making an examination appointment, medical image data as to a patient as a target of the examination from plural kinds of medical image data stored in a storing medium according to the signal and transmitting the medical image data as to the patient to the first client terminal so as to display a medical image based on the medical image data as to the patient in the first client terminal; (b) transmitting examination appointment data as to the patient from the first client terminal; (c) storing the examination appointment data as to the patient received from the first client terminal in correspondence with the medical image data as to the patient; and (d) transmitting the examination appointment data and medical image data as to the patient to the second client terminal so as to display contents of the examination appointment data as to the patient together with the medical image based on the medical image data as to the patient in the second client terminal.

According to the present invention, since the contents of examination request can be displayed together with a past medical image of a patient as a target of the examination in a terminal at an examination request client or an examination request addressee at a time of making an appointment of an examination for diagnosis from the terminal of the examination request client via a network, the examination can be facilitated.

### BRIEF DESCRIPTION OF THE DRAWINGS

FIG. 1 shows the configuration of a medical system using a server according to one embodiment of the present invention;

FIG. 2 is a block diagram showing the configuration of the server as shown in FIG. 1;

FIG. 3 is a flowchart showing the first examination appointment processing in the medical system as shown in FIG. 1;

FIG. 4 shows the first example of an examination appointment screen displayed in the client terminal 2 as shown in FIG. 1;

FIG. 5 shows the second example of the examination appointment screen displayed in the client terminal 2 as shown in FIG. 1;

FIG. 6 shows the third example of the examination appointment screen displayed in the client terminal 2 as shown in FIG. 1;

FIG. 7 shows the association between the examination appointment data stored in the examination appointment data storing unit and the medical image data stored in the medical image data storing unit as shown in FIG. 2;

FIG. 8 is a flowchart showing the second examination appointment processing in the medical system as shown in FIG. 1;

FIG. 9 shows a format of medical image data stored in the medical image data storing unit as shown in FIG. 2; and

FIG. 10 is a flowchart showing the examination appointment data display processing in the medical system as shown in FIG. 1.

### DESCRIPTION OF THE PREFERRED EMBODIMENTS

Hereinafter, an embodiment of the present invention will be described in detail by referring to the drawings. The same component elements are assigned with the same reference numerals and the description thereof will be omitted.

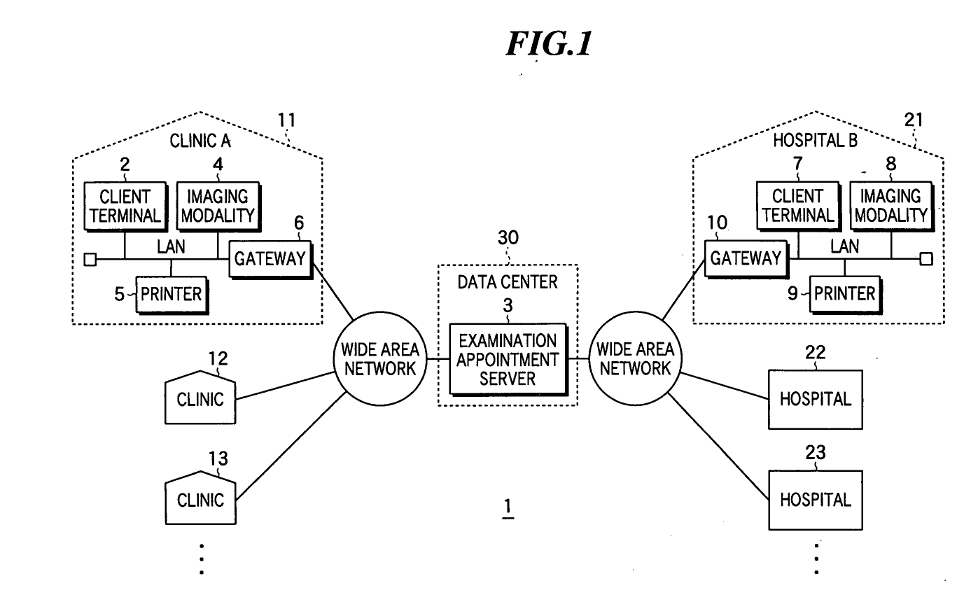

FIG. 1 shows a medical system using a server according to one embodiment of the present invention. The server according to the one embodiment of the present invention is to be used for making appointments of examinations in hospitals and storing medical image data obtained by the examination (imaging of medical images) in hospitals and clinics. Hereinafter, the server is referred to as an “examination appointment server”.

As shown in FIG. 1, a medical system 1 is configured by connecting clinics 11, 12, 13, . . . and hospitals 21, 22, 23, . . . as examples of medical facilities to a data center 30 via a wide area network. As the wide area network, a dedicated line, a public line, the internet, or the like can be utilized. An examination appointment server 3 is provided in the data center 30, and thereby, the examinations to be performed in the hospitals 21, 22, 23, . . . can be appointed from the clinics 11, 12, 13, . . . .

In each of the clinics 11, 12, 13, . . . , an imaging modality 4 such as a radiation imaging apparatus or ultrasonic diagnosing apparatus, a client terminal 2 for transferring medical image data received from the imaging modality 4 to the examination appointment server 3 within the data center 30, a printer 5 for printing out medical images on films or the like, a gateway 6 having a firewall function, etc. are connected to each others via a local area network (LAN).

The client terminal 2 controls the imaging modality 4, and receives image data from the imaging modality 4 and stores the image data in a predetermined period. Further, the client terminal 2 can perform image processing on image data and display images for diagnosis based on the image data.

Since the amount of medical image data accumulated everyday is enormous, without being stored in the clinics for a long period, the medical data is transferred to the examination appointment server 3 within the data center 30 located apart from the clinics, and the medical data is stored there. Thereby, in the clinics, space for storing recording media in which medical data is stored and the cost for securing the space can be reduced.

In each of the hospitals 21, 22, 23, . . . , various kinds of imaging modality such as a CT (Computed Tomography) apparatus and MRI (Magnetic Resonance Imaging) apparatus (only one modality 8 is shown in FIG. 1), a client terminal 7 for transferring medical image data received from the imaging modality 8 to the examination appointment server 3 within the data center 30, a printer 9 for printing out medical images on films or the like, a gateway 10 having a firewall function, etc. are connected to each others via a local area network (LAN).

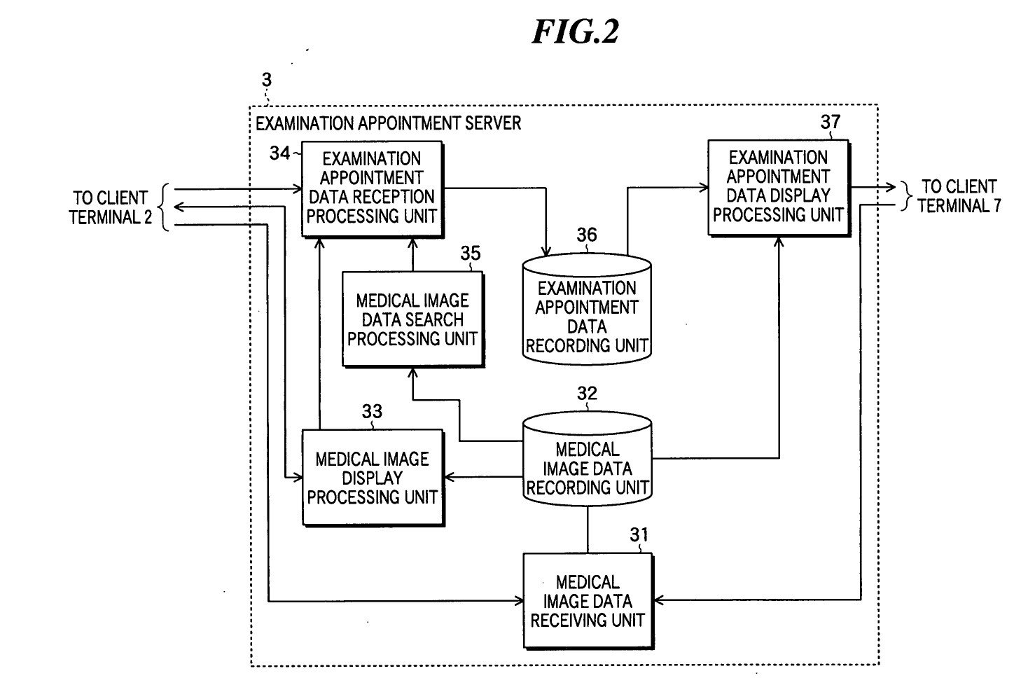

FIG. 2 is a block diagram showing the configuration of the examination appointment server as shown in FIG. 1. As shown in FIG. 2, the examination appointment server 3 includes a medical image data receiving unit 31, a medical image data storing unit 32, a medical image display processing unit 33, an examination appointment data reception processing unit 34, a medical image data search processing unit 35, an examination appointment data storing unit 36, and an examination appointment data display processing unit 37.

The medical image data receiving unit 31 receives medical image data from the client terminal 2 provided in each of the clinics 11, 12, 13, . . . and client terminal 7 provided in each of the hospitals 21, 22, 23, . . . , and causes the medical image data storing unit 32 to store the received medical image data. Thereby, in the clinics 11, 12, 13, . . . and the hospitals 21, 22, 23, . . . , space for storing recording media in which medical data is recorded and the cost for securing the space can be reduced.

When a signal of requesting for displaying a medical image is transmitted from the client terminal 2 at a time of making an examination appointment, the medical image display processing unit 33 selects medical image data as to a patient as a target of the examination from plural kinds of medical data stored in the medical image data storing unit 32 according to the signal, and transmits the medical image data of interest to the client terminal 2, and thereby, displays an image based on the medical image data of interest on the display unit of the client terminal 2.

In the case where the medical image display processing unit 33 causes the client terminal 2 to display the medical image of the target patient of examination according to the request from the client terminal 2, the examination appointment data reception processing unit 34 causes the examination appointment data storing unit 36 to store the examination appointment data as to the target patient of examination received from the client terminal 2 in correspondence with the medical image data of the target patient of examination.

On the other hand, in the case where, with no request from the client terminal 2, the medical image display processing unit 33 does not cause the client terminal 2 to display the medical image of the target patient of examination, the examination appointment data reception processing unit 34 causes the medical image data search processing unit 35 to perform searching for medical image data of the target patient of examination based on the examination appointment data as to the target patient of examination received from the client terminal 2.

When receiving an instruction from the examination appointment data reception processing unit 34, the medical image data search processing unit 35 searches, from the plural kinds of medical image data stored in the medical image data storing unit 32, for medical image data of the target patient of examination based on the examination appointment data of the target patient of examination received by the examination appointment data reception processing unit 34 from the client terminal 2. The examination appointment data reception processing unit 34 causes the examination appointment data storing unit 36 to store the examination appointment data as to the target patient of examination received from the client terminal 2 in correspondence with the medical image data retrieved by the medical image data search processing unit 35.

The examination appointment data display processing unit 37 transmits the examination appointment data and medical image data as to the target patient of examination stored in the examination appointment data storing unit 36 to the client terminal 7 so as to display in the client terminal 7 the contents of the examination appointment data together with the medical image based on the medical image data as to the target patient of examination which data is associated with the examination appointment data of interest.

The medical image display processing unit 33, the examination appointment data reception processing unit 34, the medical image data search processing unit 35, and the examination appointment data display processing unit 37 as shown in FIG. 2 are formed by a CPU and software (examination appointment program). The examination appointment program, medical image data, and examination appointment data can be stored in a storing medium such as a hard disk, a flexible disk, an MO, an MT, a RAM, a CD-ROM, or a DVD-RAM.

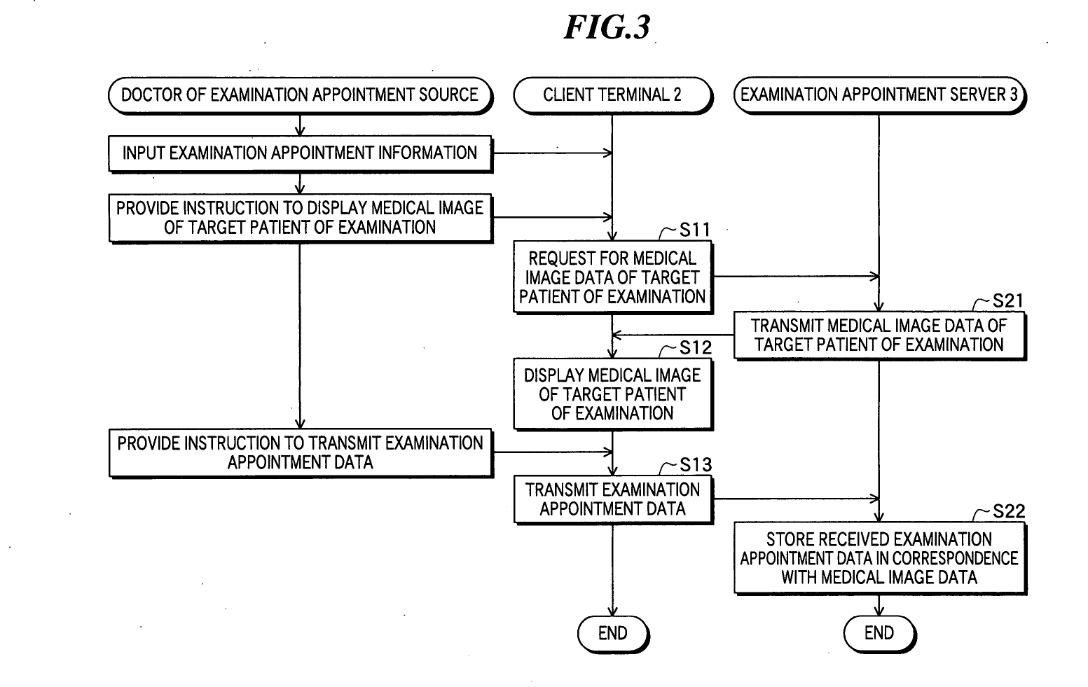

Hereinafter, the first examination appointment processing in the medical system as shown in FIG. 1 will be described by referring to FIGS. 2 and 3. FIG. 3 is a flowchart showing the first examination appointment processing in the medical system as shown in FIG. 1. Note that, the first examination appointment processing corresponds to processing in the case where a doctor in charge of making an examination appointment provides an instruction to display a medical image of the target patient of examination when the doctor inputs data for the examination appointment. Further, in the embodiment, it is assumed that a doctor of the clinic A makes an appointment of an examination that utilizes the imaging modality 8 of the hospital B (see FIG. 1).

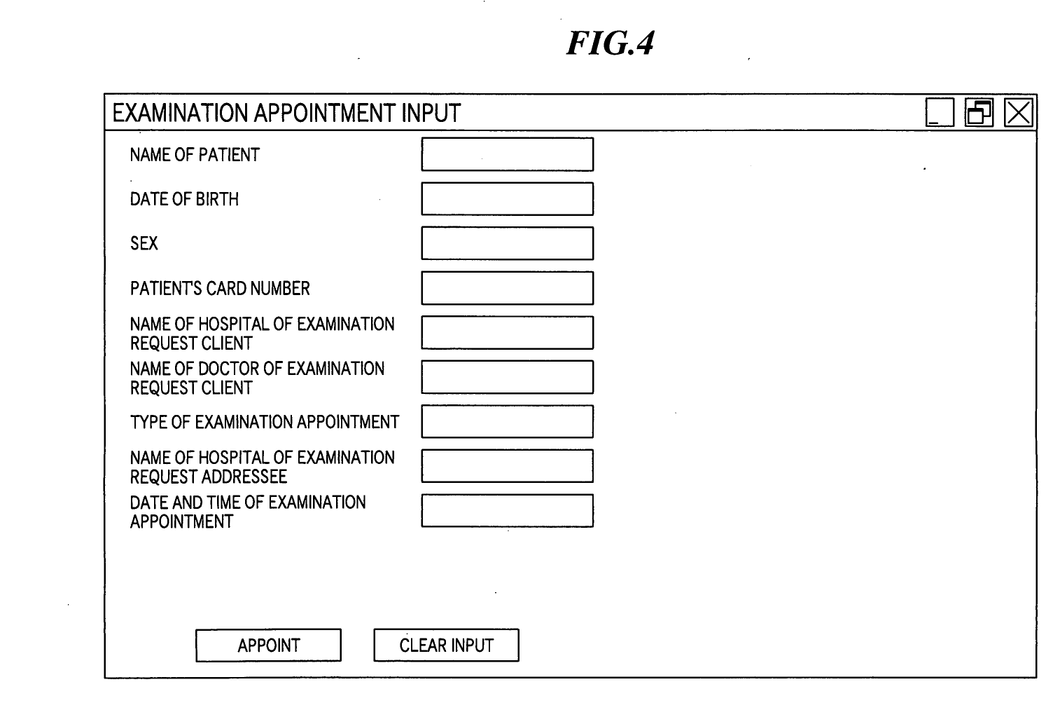

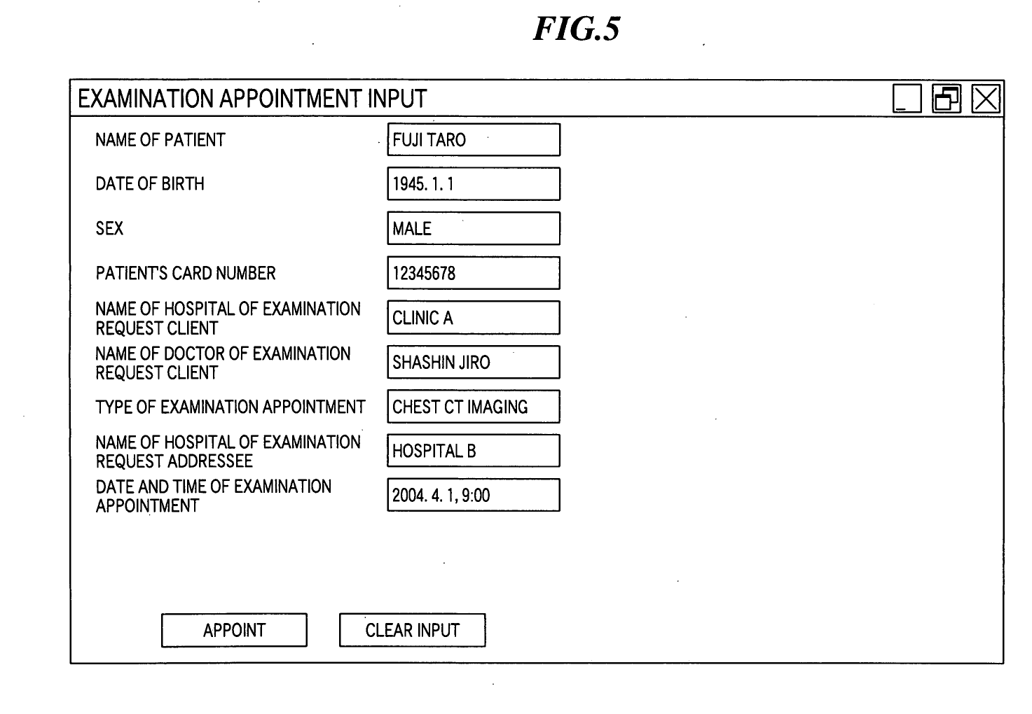

The examination appointment input screen shown in FIG. 4 is displayed on the display unit of the client terminal 2, and the doctor in charge of making an examination appointment inputs data for the examination appointment (here, name of patient, date of birth, sex, patient's card number, name of hospital of examination request client, name of doctor of examination request client, type of examination appointment, name of hospital of examination request addressee, and date and time of examination appointment) according to the examination appointment input screen. These items are just examples and not essential, but other items may be inputted. FIG. 5 shows the display screen of the client terminal 2 when these items are inputted. Here, it is assumed that a doctor makes an examination appointment of a patient whose name is “Fuji Taro”.

Furthermore, when the doctor in charge of making an examination appointment provides an instruction to display a desired medical image (here, a chest X-ray image of the target patient of examination “Fuji Taro”), the client terminal 2 transmits a signal of requesting for medical image data as to the target patient of examination to the examination appointment server 3 in order to display a medical image at the time of making the examination appointment (step S11). Here, the doctor in charge of making the examination appointment may directly designate the medical image data of the target patient of examination by using a directory path and/or a file name, or URL (Uniform Resource Locator), or may select a desired medical image after allowing plural medical images, which are imaged in the clinic A and stored in the examination appointment server 3, to be displayed in a thumbnailed form, or may designate a desired medical image data by inputting the name of the target patient of examination, the date of birth, the date and time of imaging, and so on.

The medical image display processing unit 33 of the examination appointment server 3 selects medical image data of the target patient of examination from plural kinds of medical data stored in the medical image data storing unit 32 and transmits the selected medical image data to the client terminal 2 in response to the request from the client terminal 2 (step S21). Together therewith, the medical image display processing unit 33 notifies the directory path and/or the filename, the URL, or the liked is played on the client terminal 2 to the examination appointment data reception processing unit 34.

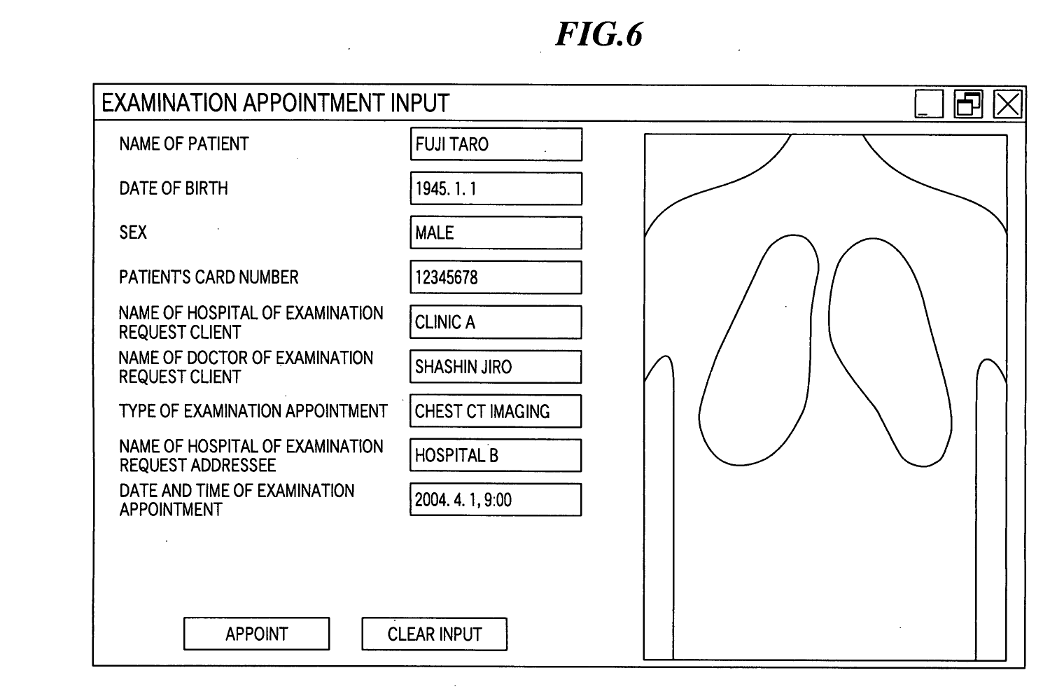

When receiving the medical image data of the target patient of examination, the client terminal 2 displays the medical image based on the received medical image data on the display unit (step S12). FIG. 6 shows the display screen of the client terminal 2 at this time.

When the doctor in charge of making the examination appointment designates the transmission of the examination appointment data (clicks “APPOINT” as shown in FIG. 6) according to the display screen, the client terminal 2 transmits the examination appointment data inputted by the doctor to the examination appointment server 3 (step S13).

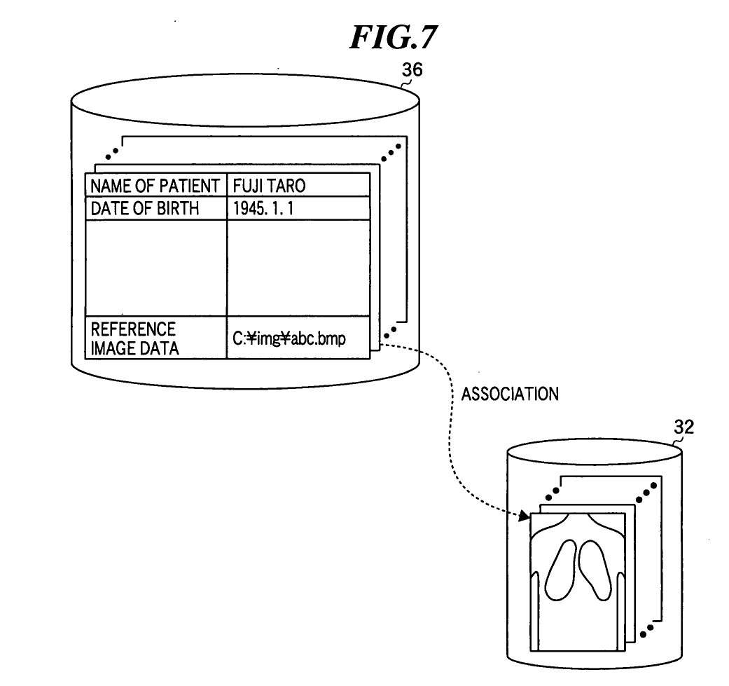

The examination appointment data reception processing unit 34 within the examination appointment server 3 checks whether or not there is an examination appointment that overlaps in the period, and then, causes the examination appointment data storing unit 36 to store the received examination appointment data in correspondence with the selected medical image data, i.e., the medical image data representing the medical image displayed on the client terminal 2 under control of the medical image display processing unit 33 (step S22). For example, as shown in FIG. 7, the examination appointment data reception processing unit 34 causes the examination appointment data storing unit 36 to store the examination appointment data with the directory path and the file name of the medical image data of the target patient of examination added to the end of the examination appointment data. The URL may be added in place of the directory path and the file name, or other identifiers, pointers, or the like for identifying the image data may be added to the examination appointment data.

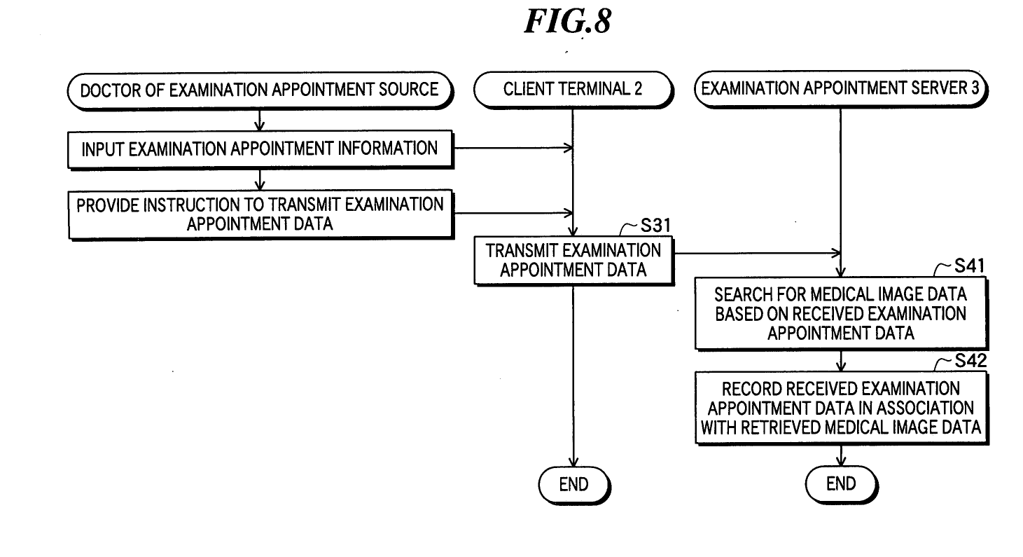

Next, the second examination appointment processing in the medical system as shown in FIG. 1 will be described by referring to FIGS. 1-5 and 8-9. FIG. 8 is a flowchart showing the second examination appointment processing in the medical system as shown in FIG. 1. Note that, the second examination appointment processing corresponds to processing in the case where a doctor in charge of making an examination appointment does not provide any instruction to display the medical image of the target patient of examination when the doctor inputs data for the examination appointment.

The examination appointment input screen (see FIG. 4) is displayed on the display screen of the client terminal 2, and the doctor in charge of making an examination appointment inputs data for the examination appointment (here, name of patient, etc.) to the client terminal (see FIG. 5). Then, when the doctor in charge of making an examination appointment provides an instruction to transmit the examination appointment data (clicks “APPOINT”) without providing any instruction to display the medical image of the target patient of examination, the client terminal 2 transmits the examination appointment data inputted by the doctor to the examination appointment server 3 (step S31).

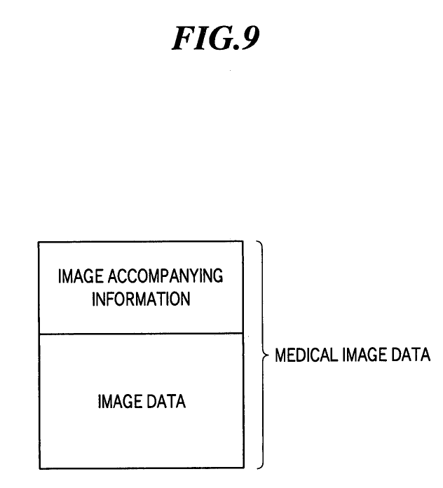

The examination appointment data reception processing unit 34 within the examination appointment server 3 checks whether or not there is an examination appointment that overlaps in the period, and then, instructs the medical image data search processing unit 35 to search for the medical image data of the target patient of examination based on the received examination appointment data. The medical image data search processing unit 35 searches for the medical image data of the target patient of examination based on the examination appointment data (step S41). Generally, image accompanying information is added to the medical image data as shown in FIG. 9, and the image accompanying information contains patient information such as the name of patient and examination information such as the imaging date. Accordingly, the medical image data search processing unit 35 can search for the medical image data of the target patient of examination by using the patient information and the examination information contained in the examination appointment data.

The examination appointment data reception processing unit 34 causes the examination appointment data storing unit 36 to store the examination appointment data received from the client terminal 2 in correspondence with the medical image data of the target patient of examination retrieved by the medical image data search processing unit 35 (step S42).

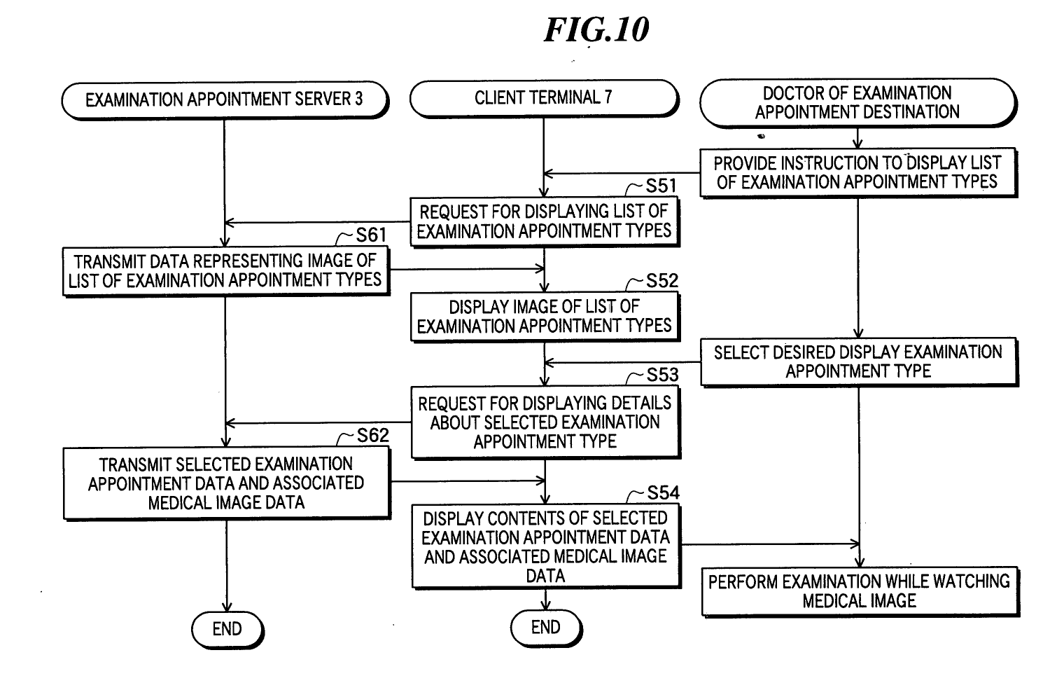

Next, the examination appointment data display processing in the medical system in FIG. 1 will be described by referring to FIG. 10. FIG. 10 is a flowchart showing the examination appointment data display processing in the medical system as shown in FIG. 1.

When confirming the status of examination appointment, performing an examination, and so on in the hospitals 21, 22, 23, . . . , a doctor or laboratory technician in the hospitals 21, 22, 23, . . . instructs the client terminal 7 to display the list of examination appointment contents. When receiving the instruction to display the list of examination appointment contents, the client terminal 7 transmits a signal of requesting for displaying the list of examination appointment contents to the examination appointment server 3 (step S51).

When receiving the signal of requesting for displaying the list of examination appointment contents from the client terminal 7, the examination appointment server 3 creates data representing an image of the list of examination appointment contents, in which the hospital (the hospital B in the embodiment) provided with the client terminal 7 is designated as an examination request addressee hospital, based on the stored examination appointment data, and transmits the data to the client terminal 7 (step S61).

The client terminal 7 receives data representing the image of the list of examination appointment contents and displays the list of examination appointment contents on the display unit (step S52).

Then, when the doctor or the like in the hospital B selects a desired examination appointment content from the list of examination appointment contents, the client terminal 7 requests for displaying details about the selected examination appointment content to the examination appointment server 3 (step S53).

When receiving the request for displaying details about the selected examination appointment content from the client terminal 7, the examination appointment server 3 transmits the examination appointment data representing the examination appointment content selected by the doctor or the like and the medical image data associated with the examination appointment data to the client terminal 7 based on the stored examination appointment data (step S62).

The client terminal 7 displays on the display unit a medical image based on the content of the examination appointment data and the medical image data associated with the examination appointment data transmitted from the examination appointment server 3 (step S54). The doctor or the like of the hospital B performs the appointed examination while watching the contents of the examination appointment data and the medical image based on the medical image data associated with the examination appointment data.

As described above, according to the embodiment, in the case where the medical image of the target patient of examination is displayed on the client terminal 2 at the time of making an examination appointment, the examination appointment data is stored in correspondence with the medical image data in the examination appointment data storing unit 36. Further, in the case where no medical image of the target patient of examination is displayed on the client terminal 2 at the time of making an examination appointment, the examination appointment data is stored in correspondence with the medical image data retrieved based on the content of the examination appointment data in the examination appointment data storing unit 36.

On the other hand, in the client terminal 7 provided in the hospital in which the appointed examination is performed, the content of the examination appointment data and the medical image based on the medical image data associated with the examination appointment data are displayed based on the examination appointment data stored as described above. Therefore, the doctor or the like who performs the appointed examination can perform the examination while watching the medical image data of the target patient of examination, and thereby, the invention can facilitate the examination.

1. A method of making an appointment of an examination for diagnosis by communicating between a first client terminal at an examination request client and a server and communicating between said server and a second client terminal at an examination request addressee via a network, said method comprising the steps of:
(a) selecting, when a signal of requesting for displaying an medical image is transmitted from said first client terminal to said server at a time of making an examination appointment, medical image data as to a patient as a target of the examination from plural kinds of medical image data stored in a storing medium according to the signal and transmitting the medical image data as to the patient from said server to said first client terminal so as to display a medical image based on the medical image data as to the patient in said first client terminal;
(b) transmitting examination appointment data as to the patient from said first client terminal to said server;
(c) storing in said server the examination appointment data as to the patient received from said first client terminal in correspondence with the medical image data as to the patient; and
(d) transmitting the examination appointment data and the medical image data as to the patient from said server to said second client terminal so as to display contents of the examination appointment data as to the patient together with the medical image based on the medical image data as to the patient in said second client terminal.

2. The method according to claim 1, wherein step (c) includes storing the examination appointment data as to the patient received from said first client terminal in correspondence with the medical image data selected at step (a).

3. The method according to claim 1, further comprising the step of:
(b′) searching, when no signal of requesting for displaying an medical image is transmitted from said first client terminal to said server at the time of making an examination appointment, for medical image data as to the patient from plural kinds of medical image data stored in said storing medium based on the examination appointment data as to the patient received from said first client terminal;
wherein step (c) includes storing in said server the examination appointment data as to the patient in correspondence with the medical image data as to the patient retrieved at step (b′).

4. A server for making an appointment of an examination for diagnosis by communicating with a first client terminal at an examination request client and communicating with a second client terminal at an examination request addressee via a network, said server comprising:
medical image data storing means for storing plural kinds of medical image data;
examination appointment data storing means for storing plural kinds of examination appointment data;
medical image display processing means for selecting, when a signal of requesting for displaying an medical image is transmitted from said first client terminal to said server at a time of making an examination appointment, medical image data as to a patient as a target of the examination from the plural kinds of medical image data stored in said medical image data storing means according to the signal and transmitting the medical image data as to the patient to said first client terminal so as to display a medical image based on the medical image data as to the patient in said first client terminal;
examination appointment data reception processing means for causing said examination appointment data storing means to store the examination appointment data as to the patient received from said first client terminal in correspondence with the medical image data as to the patient; and
examination appointment data display processing means for transmitting the examination appointment data and medical image data as to the patient to said second client terminal so as to display contents of the examination appointment data as to the patient together with the medical image based on the medical image data as to the patient in said second client terminal.

5. The server according to claim 4, wherein said examination appointment data reception processing means causes said examination appointment data storing means to store the examination appointment data as to the patient received from said first client terminal in correspondence with the medical image data selected by said medical image display processing means.

6. The server according to claim 4, further comprising:
medical image data search processing means for searching, when no signal of requesting for displaying an medical image is transmitted from said first client terminal to said server at the time of making an examination appointment, for medical image data as to the patient from the plural kinds of medical image data stored in said medical image data storing means based on the examination appointment data as to the patient received by said examination appointment data reception processing means from said first client terminal;
wherein said examination appointment data reception processing means causes said examination appointment data storing means to store the examination appointment data as to the patient in correspondence with the medical image data as to the patient retrieved by said medical image data search processing means.

7. A program for making an appointment of an examination for diagnosis in a server by communicating between a first client terminal at an examination request client and said server and communicating between said server and a second client terminal at an examination request addressee via a network, said program actuating a CPU to execute the procedures of:
(a) selecting, when a signal of requesting for displaying an medical image is transmitted from said first client terminal to said server at a time of making an examination appointment, medical image data as to a patient as a target of the examination from plural kinds of medical image data stored in a storing medium according to the signal and transmitting the medical image data as to the patient to said first client terminal so as to display a medical image based on the medical image data as to the patient in said first client terminal;
(b) receiving examination appointment data as to the patient from said first client terminal;
(c) storing the examination appointment data as to the patient received from said first client terminal in correspondence with the medical image data as to the patient; and
(d) transmitting the examination appointment data and medical image data as to the patient to said second client terminal so as to display contents of the examination appointment data as to the patient together with the medical image based on the medical image data as to the patient in said second client terminal.

8. The program according to claim 7, wherein procedure (c) includes storing the examination appointment data as to the patient received from said first client terminal in correspondence with the medical image data selected at procedure (a).

9. The program according to claim 7, further actuating the CPU to execute the procedure of:
(b′) searching, when no signal of requesting for displaying an medical image is transmitted from said first client terminal to said server at the time of making an examination appointment, for medical image data as to the patient from the plural kinds of medical image data stored in said storing medium based on the examination appointment data as to the patient received from said first client terminal;
wherein procedure (c) includes storing the examination appointment data as to the patient in correspondence with the medical image data as to the patient retrieved at procedure (b′).
